(19) United States
(12) Patent Application Publication
(10) Pub. No.: US 2025/0212185 A1
(43) Pub. Date: Jun. 26, 2025

(54) METHOD, DEVICE AND COMPUTER STORAGE MEDIUM OF COMMUNICATION

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 18/848,154

(22) PCT Filed: Mar. 21, 2022
(86) PCT No.: PCT/CN2022/082029

§ 371 Date: Sep. 18, 2024

(51) Int. Cl. H04W 72/0446; H04L 5/14; H04W 84/04

(52) U.S. Cl. CPC H04W 72/0446; H04L 5/14; H04W 84/047

(57) ABSTRACT

Embodiments of the present disclosure relate to methods, devices and computer readable media for communication. A network device determines at least one of first information, second information or third information, the first information indicating a TDD configuration for a terminal device, the second information indicating at least one of a power level or a hardware state of a repeater device, the third information indicating channel qualities of a first link between the network device and the terminal device via the repeater device and a second link between the network device and the terminal device. The network device determines control information indicating turn-on or turn-off of the repeater device based on the at least one of the first information, the second information or the third information, and transmit the control information to the repeater device. In this way, determination and transmission of on-off information for a network-controlled repeater device is defined.

### TECHNICAL FIELD

Embodiments of the present disclosure generally relate to the field of telecommunication, and in particular, to methods, devices and computer storage media of communication for a network-controlled repeater.

### BACKGROUND

Coverage is a fundamental aspect of cellular network deployments. As known, a radio frequency (RF) repeater may be utilized to simply amplify-and-forward any signal that they receive. While the RF repeater presents a cost effective means of extending network coverage, the RF repeater simply does an amplify-and-forward operation without being able to take into account various factors that could improve performance.

Recently, a network-controlled repeater is introduced by adding side control information for beam management on a basis of the RF repeater to extend the coverage in a high frequency (HF) with a higher efficient method. It has been proposed that the side control information may comprise on-off information for efficient interference management and improved energy efficiency. However, details about the on-off information for the network-controlled repeater are still undefined and need to be developed.

### SUMMARY

In general, embodiments of the present disclosure provide methods, devices and computer storage media of communication for a network-controlled repeater.

In a first aspect, there is provided a method of communication. The method comprises: determining, at a network device, at least one of first information, second information or third information, the first information indicating a time-division duplexing configuration for a terminal device, the second information indicating at least one of a power level or a hardware state of a repeater device, the third information indicating channel qualities of a first link between the network device and the terminal device via the repeater device and a second link between the network device and the terminal device: determining control information based on the at least one of the first information, the second information or the third information, the control information indicating turn-on or turn-off of the repeater device; and transmitting the control information to the repeater device.

In a second aspect, there is provided a method of communication. The method comprises: transmitting, at a repeater device and to a network device, second information indicating at least one of a power level or a hardware state of the repeater device; and receiving, from the network device, control information indicating turn-on or turn-off of the repeater device.

In a third aspect, there is provided a method of communication. The method comprises: generating, at a terminal device, third information indicating channel qualities of a first link between a network device and the terminal device via a repeater device and a second link between the network device and the terminal device; and transmitting the third information to a network device.

In a fourth aspect, there is provided a network device. The network device comprises a processor configured to cause the network device to perform the method according to the first aspect of the present disclosure.

In a fifth aspect, there is provided a repeater device. The repeater device comprises a processor configured to cause the repeater device to perform the method according to the second aspect of the present disclosure.

In a sixth aspect, there is provided a terminal device. The terminal device comprises a processor configured to cause the terminal device to perform the method according to the third aspect of the present disclosure.

In a seventh aspect, there is provided a computer readable medium having instructions stored thereon. The instructions, when executed on at least one processor, cause the at least one processor to perform the method according to the first or second or third aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a schematic diagram illustrating an example process of communication according to embodiments of the present disclosure:

FIG. 3A illustrates a schematic diagram illustrating an example determination of control information in the case that a granularity of on-off state is slot according to embodiments of the present disclosure:

FIG. 3B illustrates a schematic diagram illustrating another example determination of control information in the case that a granularity of on-off state is slot according to embodiments of the present disclosure:

FIG. 3C illustrates a schematic diagram illustrating still another example determination of control information in the case that a granularity of on-off state is slot according to embodiments of the present disclosure:

FIG. 4A illustrates a schematic diagram illustrating an example determination of control information in the case that a granularity of on-off state is symbol according to embodiments of the present disclosure:

FIG. 4B illustrates a schematic diagram illustrating another example determination of control information in the case that a granularity of on-off state is symbol according to embodiments of the present disclosure:

FIG. 4C illustrates a schematic diagram illustrating still another example determination of control information in the case that a granularity of on-off state is symbol according to embodiments of the present disclosure:

FIG. 5 illustrates a schematic diagram illustrating an example on-off operation of the repeater device according to embodiments of the present disclosure:

FIG. 6A illustrates a schematic diagram illustrating an example process for determining control information based on a repeater state according to embodiments of the present disclosure:

FIG. 6B illustrates a schematic diagram illustrating an example process for determining control information based on a channel state according to embodiments of the present disclosure:

FIG. 7A illustrates a schematic diagram illustrating an example transmission of control information according to embodiments of the present disclosure:

FIG. 7B illustrates a schematic diagram illustrating another example transmission of control information according to embodiments of the present disclosure:

FIG. 8 illustrates an example method of communication implemented at a network device in accordance with some embodiments of the present disclosure:

FIG. 9 illustrates an example method of communication implemented at a repeater device in accordance with some embodiments of the present disclosure:

FIG. 10 illustrates an example method of communication implemented at a terminal device in accordance with some embodiments of the present disclosure; and

FIG. 11 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below:

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHZ), FR2 (24.25 GHz to 71 GHZ), frequency band larger than 100 GHZ as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below:

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present application, the term “repeater” may be interchangeably used with “repeater device” or “network-control repeater”, and the term “beam” may be interchangeably used with “link” or “channel” or “spatial filter”. In the context of the present application, the term “side control information” may be interchangeably used with “control information” or “on-off information”. In the context of the present application, the term “synchronization signal and physical broadcast channel block (SSB) index” may be interchangeably used with “channel state information-reference signal (CSI-RS) index”.

In the context of the present application, a slot may comprise 14 symbols if a cyclic prefix (CP) length is a normal CP, and a slot may comprise 12 symbols if a CP length is an extended cyclic prefix (ECP). For convenience, embodiments of the present disclosure are described in connection with a normal CP. It is to be understood that embodiments of the present disclosure may also be applied in connection with ECP.

Currently, it is intended to study and identify which side control information below is necessary for network-controlled repeaters including assumption of maximum transmission power:
beamforming information:
timing information to align transmission/reception boundaries of a network-controlled repeater:
information on uplink (UL)-downlink (DL) time division duplexing (TDD) configuration:
on-off information for efficient interference management and improved energy efficiency:
power control information for efficient interference management (as the second priority).

As mentioned above, details about the on-off information need to be developed. In view of this, embodiments of the present disclosure provide a solution for determination and transmission of the on-off information for a network-controlled repeater. In the solution, control information (i.e., the on-off information) is determined based on at least one of a TDD configuration for a terminal device, a state of a repeater device, or channel qualities of links among a network device, the terminal device and the repeater device. The control information is transmitted on a dedicated resource.

In this way, a relationship between the on-off information and other communication parameters is defined and a more effective working mode of a repeater device is ensured. Further, a resource allocation for the on-off information transmission is defined and a flexible wording mode switching of a repeater device is ensured.

Principles and implementations of the present disclosure will be described in detail below with reference to the figures.

### Example of Communication Network

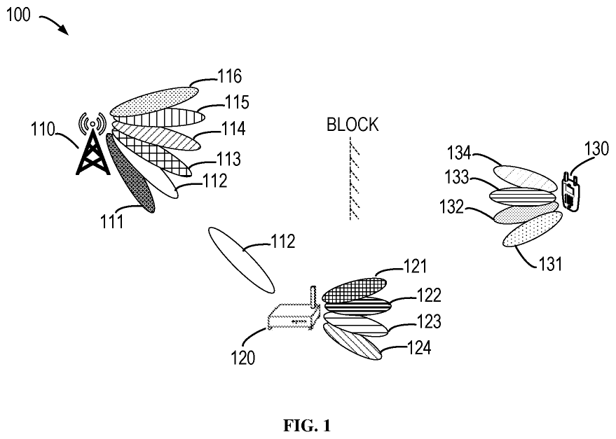

FIG. 1 illustrates a schematic diagram of an example communication network 100 in which embodiments of the present disclosure can be implemented. As shown in FIG. 1, the communication network 100 may comprise a network device 110, a repeater device 120 and a terminal device 130. The network device 110 may serve the terminal device 130.

In some embodiments, the network device 110 may directly communicate with the terminal device 130. In this case, a link between the network device 110 and the terminal device 130 is a direct link (for convenience, also referred to as a second link). In some embodiments, the network device 110 may communicate with the terminal device 130 via the repeater device 120. In this case, a link between the network device 110 and the terminal device 130 via the repeater device 120 is an indirect link (for convenience, also referred to as a first link). The first link comprises a first sub-link between the network device 110 and the repeater device 120 and a second sub-link between the repeater device 120 and the terminal device 130.

The repeater device 120 may have a forwarding function (also referred to as a normal operation mode) and a monitoring function (also referred to as a low power consumption mode). In the normal operation mode, the repeater device 120 may forward a signal transmission between the network device 110 and the terminal device 130. That is, the repeater device 120 may receive a signal from the network device 110, then amplify the received signal and forward the amplified signal to the terminal device 130. Or the repeater device 120 may receive a signal from the terminal device 130, then amplify the received signal and forward the amplified signal to the network device 110. In the low power consumption mode, the repeater device 120 may intermittently or periodically monitor a signal from the network device 110.

In some embodiments, the network device 110 may transmit side control information to the repeater device 120. The side control information may comprise at least one of the following: beamforming information, timing information to align transmission or reception boundaries of the repeater device 120, information on UL-DL TDD configuration, on-off information for efficient interference management and improved energy efficiency, or power control information for efficient interference management.

As shown in FIG. 1, the network device 110 may support six beams 111, 112, 113, 114, 115 and 116 for communication, the repeater device 120 may support five beams 121, 122, 123, 124, and 125 for communication, and the terminal device 130 may support four beams 131, 132, 133 and 134 for communication. These beams may serve as transmit beams or receive beams in DL or UL transmission. For convenience, assuming that the beams 111, 112, 113, 114, 115 and 116 are transmit beams of the network device 110 in DL transmission, the beams 121, 122, 123 and 124 are transmit beams of the repeater device 120 in DL transmission, the beam 125 is a receive beam of the repeater device 120 in DL transmission, and the beams 131, 132, 133 and 134 are receive beams of the terminal device 130 in DL transmission.

It is to be understood that the number of devices or beams in FIG. 1 is given for the purpose of illustration without suggesting any limitations to the present disclosure. The communication network 100 may involve any suitable number of network devices and/or repeater devices and/or terminal devices and/or beams adapted for implementing implementations of the present disclosure.

The communications in the communication network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some scenarios, as the terminal device 130 moves, a block may occur between the network device 110 and the terminal device 130. As shown in FIG. 1, no beam pair may be formed between the network device 110 and the terminal device 130, and a beam pair (for example, the beam 112 and the beam 125) may be formed between the network device 110 and the repeater device 120. In this case, the repeater device 120 may perform a forwarding function between the network device 110 and the terminal device 130. That is, the network device 110 may communicate with the terminal device 130 via the repeater device 120.

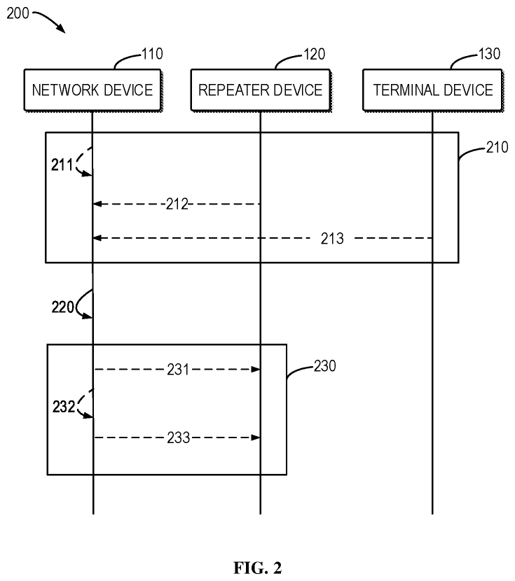

Embodiments of the present disclosure provide a solution for determination and transmission of the on-off information. The solutions will be described below with reference to FIGS. 2 to 7B.

### Example Implementation of Determination of On-Off Information

FIG. 2 illustrates a schematic diagram illustrating an example process 200 of communication according to embodiments of the present disclosure. For the purpose of discussion, the process 200 will be described with reference to FIG. 1. The process 200 may involve the network device 110, the repeater device 120 and the terminal device 130 as illustrated in FIG. 1. It to be noted that the process 200 may comprise more additional steps or omit some steps shown, and the present disclosure does not limit the order of the steps.

As shown in FIG. 2, the network device 110 determines 210 at least one of first information, second information or third information. The first information indicates a TDD configuration for the terminal device 130. The second information indicates at least one of a power level or a hardware state of the repeater device 120. The third information indicates channel qualities of the first link between the network device 110 and the terminal device 130 via the repeater device 120 and the second link between the network device 110 and the terminal device 130.

In some embodiments, the network device 110 may obtain 211 the TDD configuration locally. In some embodiments, the network device 110 may obtain 212 the second information from the repeater device 120. In some embodiments, the network device 110 may obtain 213 the third information from the terminal device 130.

Then the network device 110 determines 220 control information (i.e., on-off information) based on the at least one of first information, second information or third information. For illustration, some example embodiments for determination of the control information will be described below in connection with Embodiments 1 to 3.

### Embodiment 1

In this embodiment, the network device 110 may determine the first information (i.e., TDD configuration) and determine the control information based on the first information.

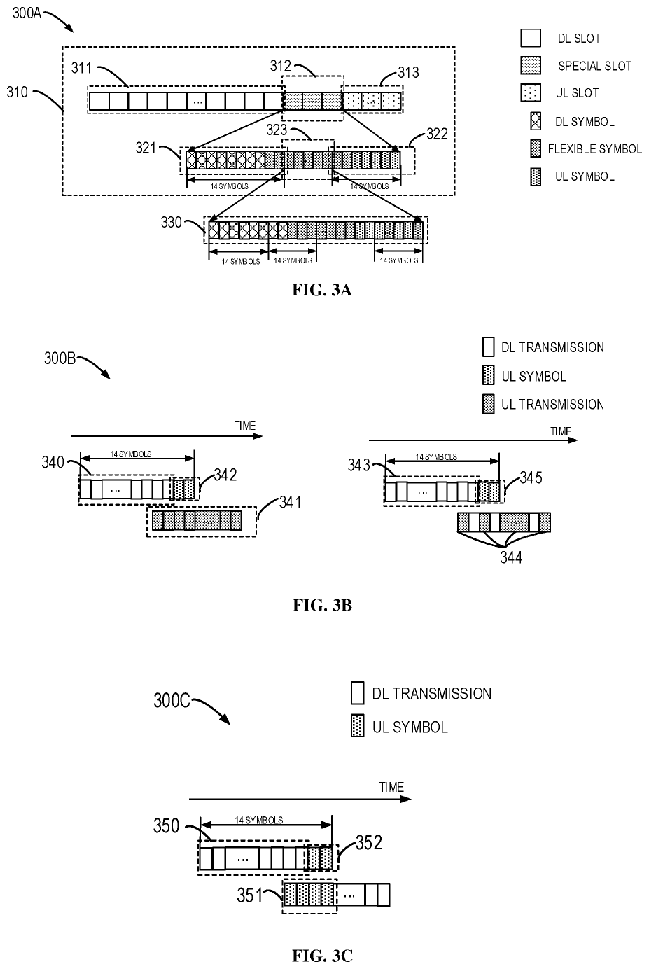

In some embodiments, if a symbol in a slot indicated in the TDD configuration is a DL symbol, the network device 110 may cause the control information to be to indicate the turn-on of the repeater device 120 for the slot. In other words, if a slot indicated in the TDD configuration is a DL slot, the network device 110 may cause the control information to be to indicate the turn-on of the repeater device 120 for the slot. In some embodiments, if symbols in a slot indicated in the TDD configuration are UL symbols, the network device 110 may cause the control information to be to indicate the turn-off of the repeater device 120 for the slot. In other words, if a slot indicated in the TDD configuration is a UL slot, the network device 110 may cause the control information to be to indicate the turn-off of the repeater device 120 for the slot. For illustration, an example is described below in connection with FIG. 3A.

FIG. 3A illustrates a schematic diagram 300A illustrating an example determination of control information in the case that a granularity of on-off state is slot according to embodiments of the present disclosure. As shown in FIG. 3A, a slot structure 310 is indicated by TDD-UL-DL-ConfigCommon in the TDD configuration. The slot structure 310 comprises DL slots 311, special slots 312 and UL slots 313. FIG. 3A also shows a symbol structure 321 of one of the special slots 312 next to the last one of the DL slots 311, a symbol structure 322 of one of the special slots 312 adjacent to the first one of the UL slots 313 and remaining slots 323 of the special slots 312. The symbol structure 330 of the remaining slots 323 is indicated by TDD-UL-DL-ConfigDedicated in the TDD configuration.

In the example of FIG. 3A, a granularity of on-off state is slot. For each of the DL slots 311, the network device 110 may cause the control information to be to indicate the turn-on of the repeater device 120. Even the symbol structure 321 comprises DL symbols smaller than 14 symbols (i.e., 1 slot with a normal CP length, if an ECP length is applied, the number of symbols in a slot is 12), the network device 110 may cause the control information to be to indicate the turn-on of the repeater device 120 for the one of the special slots 312 next to the DL slots 311, to ensure the DL transmission. As the first 14 symbols of the symbol structure 330 are all DL symbols, the network device 110 may cause the control information to be to indicate the turn-on of the repeater device 120 for the first 14 symbols of the symbol structure 330.

For each of the UL slots 313, the network device 110 may cause the control information to be to indicate the turn-off of the repeater device 120. As the symbol structure 322 comprises UL symbols smaller than 14 symbols (i.e., 1 slot), the network device 110 may cause the control information to be to indicate the turn-on of the repeater device 120 for the one of the special slots 312 adjacent to the first UL slots 311, to ensure the possible DL transmission on the flexible symbols. As the last 14 symbols of the symbol structure 330 are all UL symbols, the network device 110 may cause the control information to be to indicate the turn-off of the repeater device 120 for the last 14 symbols of the symbol structure 330. It is to be understood that FIG. 3A is merely an example, and is not intended for limitation.

In some embodiments, if at least one DL transmission over a set of symbols indicated by a higher layer signaling conflicts with at least one UL transmission scheduled by DL control information, and the set of symbols and a set of UL symbols form a slot, the network device 110 may cause the control information to be to indicate the turn-off of the repeater device 120 for the slot. In some embodiments, the set of symbols may comprise one symbol. In some embodiments, the set of symbols may comprise multiple symbols. For illustration, an example is described below in connection with FIG. 3B.

FIG. 3B illustrates a schematic diagram 300B illustrating another example determination of control information in the case that a granularity of on-off state is slot according to embodiments of the present disclosure. As shown in FIG. 3B, the higher layer signaling indicates that at least one DL transmission is to be performed over a set of symbols 340, and downlink control information (DCI) schedules at least one UL transmission over a set of symbols 341. The set of symbols 340 is partially overlapped with the set of symbols 341. That is, the at least one DL transmission conflicts with the at least one UL transmission. As shown in FIG. 3B, the set of symbols 340 and a set of UL symbols 342 form a slot. Then, the network device 110 may cause the control information to be to indicate the turn-off of the repeater device 120 for the slot comprising the set of symbols 340 and the set of UL symbols 342.

As an example, the at least one DL transmission may be a physical downlink control channel (PDCCH), a physical downlink shared channel (PDSCH), a channel state information-reference signal (CSI-RS) or a DL positioning reference signal (PRS) transmission. As an example, the at least one UL transmission may be a physical uplink control channel (PUCCH), a physical uplink shared channel (PUSCH), a physical random access channel (PRACH) or a sounding reference signal (SRS) transmission. It is to be understood that these merely are examples, and do not limit the present disclosure.

As another example, the higher layer signaling indicates that at least one DL transmission is to be performed over a set of symbols 343, and downlink control information (DCI) schedules at least one UL transmission over a set of symbols 344. Symbols in the set of symbols 344 are discontinuous. The set of symbols 343 is partially overlapped with the set of symbols 344. That is, the at least one DL transmission conflicts with the at least one UL transmission. As shown in FIG. 3B, the set of symbols 343 and a set of UL symbols 345 form a slot. Then, the network device 110 may cause the control information to be to indicate the turn-off of the repeater device 120 for the slot comprising the set of symbols 343 and the set of UL symbols 345. It is to be understood that FIG. 3B is merely an example, and is not intended for limitation.

In some embodiments, if at least one DL transmission over a set of symbols conflicts with at least one UL symbol indicated in the TDD configuration, and the set of symbols and a set of UL symbols form a slot, the network device 110 may cause the control information to be to indicate the turn-off of the repeater device 120 for the slot. In some embodiments, the set of symbols may comprise one symbol. In some embodiments, the set of symbols may comprise multiple symbols. For illustration, an example is described below in connection with FIG. 3C.

FIG. 3C illustrates a schematic diagram 300C illustrating still another example determination of control information in the case that a granularity of on-off state is slot according to embodiments of the present disclosure. As shown in FIG. 3C, the higher layer signaling or DCI information indicates that at least one DL transmission is to be performed over a set of symbols 350. The set of symbols 350 is partially overlapped with a set of UL symbols 351 indicated in the TDD configuration. That is, the at least one DL transmission conflicts with the set of UL symbols indicated in the TDD configuration. As shown in FIG. 3C, the set of symbols 350 and a set of UL symbols 352 form a slot. Then, the network device 110 may cause the control information to be to indicate the turn-off of the repeater device 120 for the slot comprising the set of symbols 350 and the set of UL symbols 352. It is to be understood that FIG. 3C is merely an example, and is not intended for limitation.

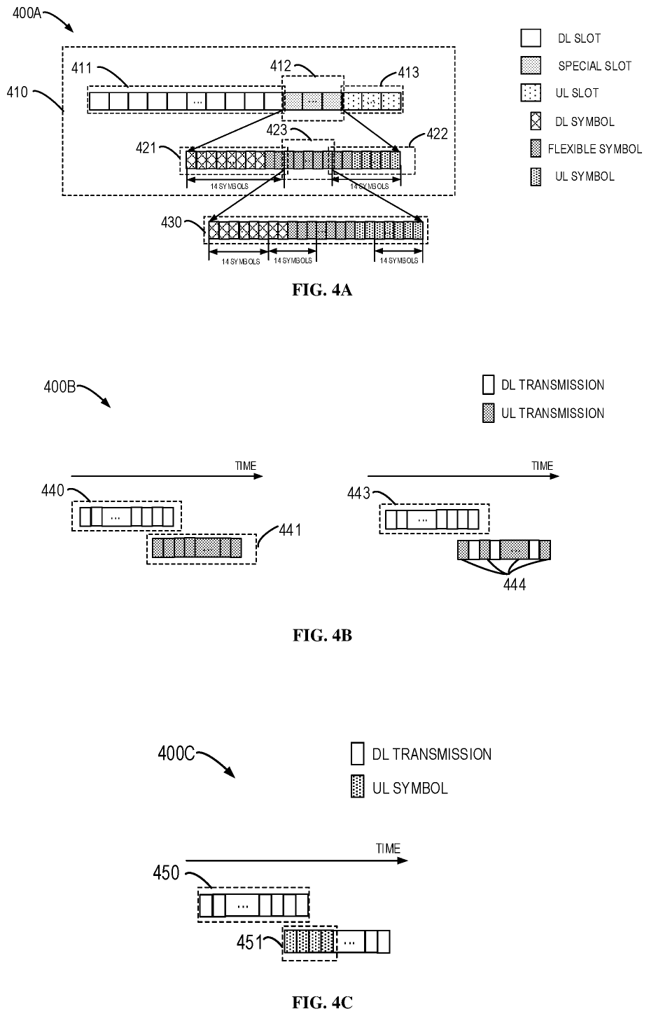

In some embodiments where a granularity of on-off state is symbol, the network device 110 may cause the control information to be to indicate the turn-on of the repeater device 120 for a DL symbol or flexible symbol. In some embodiments where a granularity of on-off state is symbol, the network device 110 may cause the control information to be to indicate the turn-off of the repeater device 120 for an UL symbol. For illustration, an example is described below in connection with FIG. 4A.

FIG. 4A illustrates a schematic diagram 400A illustrating an example determination of control information in the case that a granularity of on-off state is symbol according to embodiments of the present disclosure. As shown in FIG. 4A, a slot structure 410 is indicated by TDD-UL-DL-ConfigCommon in the TDD configuration. The slot structure 410 comprises DL slots 411, special slots 412 and UL slots 413. FIG. 4A also shows a symbol structure 421 of one of the special slots 412 next to the last one of the DL slots 411, a symbol structure 422 of one of the special slots 412 adjacent to the first one of the UL slots 413 and remaining slots 423 of the special slots 412. The symbol structure 430 of the remaining slots 423 is indicated by TDD-UL-DL-ConfigDedicated in the TDD configuration.

In the example of FIG. 4A, a granularity of on-off state is symbol. For each symbol of the DL slots 411, the network device 110 may cause the control information to be to indicate the turn-on of the repeater device 120. For DL symbols comprised in the symbol structure 421, the network device 110 may cause the control information to be to indicate the turn-off of the repeater device 120 for the DL symbols. For DL symbols comprised in the symbol structure 430, the network device 110 may cause the control information to be to indicate the turn-on of the repeater device 120 for the DL symbols.

For each symbol of the UL slots 413, the network device 110 may cause the control information to be to indicate the turn-off of the repeater device 120. For UL symbols comprised in the symbol structure 422, the network device 110 may cause the control information to be to indicate the turn-off of the repeater device 120 for the UL symbols. For UL symbols comprised in the symbol structure 430, the network device 110 may cause the control information to be to indicate the turn-off of the repeater device 120 for the UL symbols. It is to be understood that FIG. 4A is merely an example, and is not intended for limitation.

In some embodiments where a granularity of on-off state is symbol, if a DL transmission over a set of symbols indicated by a higher layer signaling conflicts with an UL transmission scheduled by DCI, the network device 110 may cause the control information to be to indicate the turn-off of the repeater device 120 for the set of symbols. In some embodiments, the set of symbols may comprise one symbol. In some embodiments, the set of symbols may comprise multiple symbols. For illustration, an example is described below in connection with FIG. 4B.

FIG. 4B illustrates a schematic diagram 400B illustrating another example determination of control information in the case that a granularity of on-off state is symbol according to embodiments of the present disclosure. As shown in FIG. 4B, the higher layer signaling indicates that at least one DL transmission is to be performed over a set of symbols 440, and DCI schedules at least one UL transmission over a set of symbols 441. The set of symbols 440 is partially overlapped with the set of symbols 441. That is, the at least one DL transmission conflicts with the at least one UL transmission. In this case, the network device 110 may cause the control information to be to indicate the turn-off of the repeater device 120 for the set of symbols 440.

As an example, the at least one DL transmission may be a PDCCH, a PDSCH, a CSI-RS or a DL PRS transmission. As an example, the at least one UL transmission may be a PUCCH, a PUSCH, a PRACH or a SRS transmission. It is to be understood that these merely are examples, and do not limit the present disclosure.

As another example, the higher layer signaling indicates that at least one DL transmission is to be performed over a set of symbols 443, and DCI schedules at least one UL transmission over a set of symbols 444. Symbols in the set of symbols 444 are discontinuous. The set of symbols 443 is partially overlapped with the set of symbols 444. That is, the at least one DL transmission conflicts with the at least one UL transmission. In this case, the network device 110 may cause the control information to be to indicate the turn-off of the repeater device 120 for the set of symbols 443. It is to be understood that FIG. 4B is merely an example, and is not intended for limitation.

In some embodiments where a granularity of on-off state is symbol, if at least one DL transmission over a set of symbols conflicts with at least one UL symbol, the network device 110 may cause the control information to be to indicate the turn-off of the repeater device 120 for the set of symbols. In some embodiments, the set of symbols may comprise one symbol. In some embodiments, the set of symbols may comprise multiple symbols. For illustration, an example is described below in connection with FIG. 4C.

FIG. 4C illustrates a schematic diagram 400C illustrating still another example determination of control information in the case that a granularity of on-off state is symbol according to embodiments of the present disclosure. As shown in FIG. 4C, the higher layer signaling or DCI information indicates that at least one DL transmission is to be performed over a set of symbols 450. The set of symbols 450 is partially overlapped with a set of UL symbols 451 indicated in the TDD configuration. That is, the at least one DL transmission conflicts with the set of UL symbols indicated in the TDD configuration. In this case, the network device 110 may cause the control information to be to indicate the turn-off of the repeater device 120 for the set of symbols 450. It is to be understood that FIG. 4C is merely an example, and is not intended for limitation.

In some embodiments, the repeater device 120 may comprise a DL transceiver and an UL transceiver. In these embodiments, the turn-on of the repeater device 120 may comprise turn-on of the DL transceiver of the repeater device 120 and turn-off of the UL transceiver of the repeater device 120. The turn-off of the repeater device 120 may comprise turn-off of the DL transceiver of the repeater device 120 and turn-on of the UL transceiver of the repeater device 120.

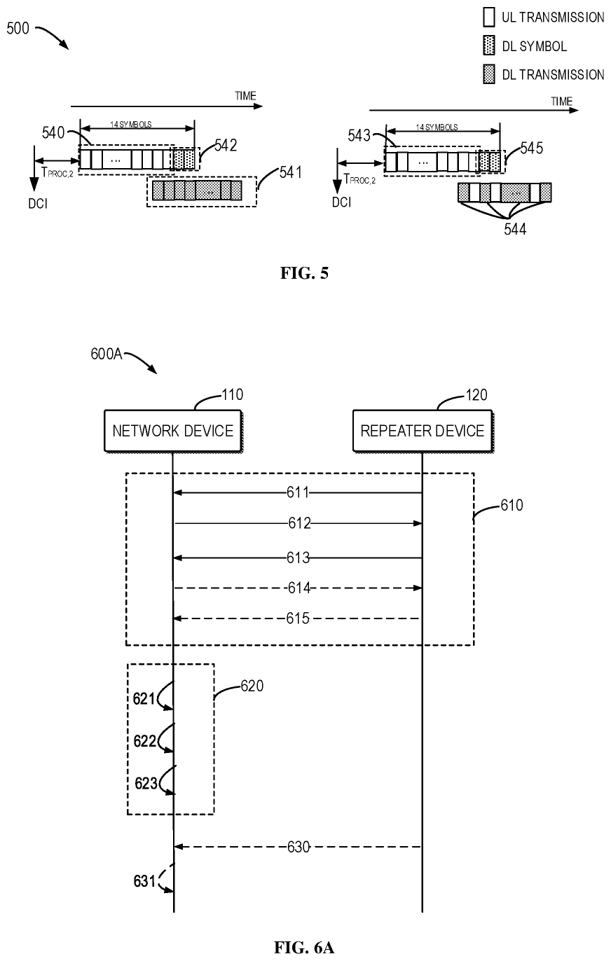

In some embodiments, if a UL transmission over a set of symbols indicated by a higher layer signaling conflicts with a DL transmission scheduled by DCI, the network device 110 may determine whether a gap between the first symbol of the set of symbols and the last symbol carrying the DCI is larger than or equal to a threshold gap. If the gap is larger than or equal to the threshold gap, the network device 110 may cause the control information to be to indicate the turn-on of the DL transceiver of the repeater device 120 and turn-off of the UL transceiver of the repeater device 120 for the set of symbols. If the gap is smaller than the threshold gap, the network device 110 may cause the control information to be to indicate the turn-on of the UL transceiver of the repeater device 120 for the set of symbols. In some embodiments, the threshold gap may be predefined or preconfigured. Of course, the threshold gap may be determined in any other suitable ways. Further, the present disclosure also does not limit the value of the threshold gap. For illustration, an example is described below in connection with FIG. 5.

FIG. 5 illustrates a schematic diagram 500 illustrating an example on-off operation of the repeater device according to embodiments of the present disclosure. As shown in FIG. 5, the higher layer signaling indicates that at least one UL transmission is to be performed over a set of symbols 540, and DCI schedules at least one DL transmission over a set of symbols 541. The set of symbols 540 is partially overlapped with the set of symbols 541. That is, the at least one UL transmission conflicts with the at least one DL transmission.

In this example, a gap between the first symbol of the set of symbols 540 and the last symbol of the DCI is equal to a threshold gap (for example, T_{proc.2}). In some embodiments where the granularity of on-off state is slot, the network device 110 may cause the control information to be to indicate the turn-on of the DL transceiver of the repeater device 120 and the turn-off of the UL transceiver of the repeater device 120 for a slot comprising the set of symbols 540 and a set of DL symbol 542. In some embodiments where the granularity of on-off state is symbol, the network device 110 may cause the control information to be to indicate the turn-on of the DL transceiver of the repeater device 120 and the turn-off of the UL transceiver of the repeater device 120 for the set of symbols 540.

As another example, the higher layer signaling indicates that at least one UL transmission is to be performed over a set of symbols 543, and DCI schedules at least one DL transmission over a set of symbols 544. Symbols in the set of symbols 544 are discontinuous. The set of symbols 543 is partially overlapped with the set of symbols 544. That is, the at least one UL transmission conflicts with the at least one DL transmission.

In this example, a gap between the first symbol of the set of symbols 543 and the last symbol of the DCI is equal to a threshold gap (for example, T_{proc.2}). In some embodiments where the granularity of on-off state is slot, the network device 110 may cause the control information to be to indicate the turn-on of the DL transceiver of the repeater device 120 and the turn-off of the UL transceiver of the repeater device 120 for a slot comprising the set of symbols 543 and a set of DL symbol 545. In some embodiments where the granularity of on-off state is symbol, the network device 110 may cause the control information to be to indicate the turn-on of the DL transceiver of the repeater device 120 and the turn-off of the UL transceiver of the repeater device 120 for the set of symbols 543. It is to be understood that FIG. 5 is merely an example, and is not intended for limitation.

If the granularity of on-off state is slot, lower complexity may be provided. If the granularity of on-off state is symbol, more flexibility may be provided.

### Embodiment 2

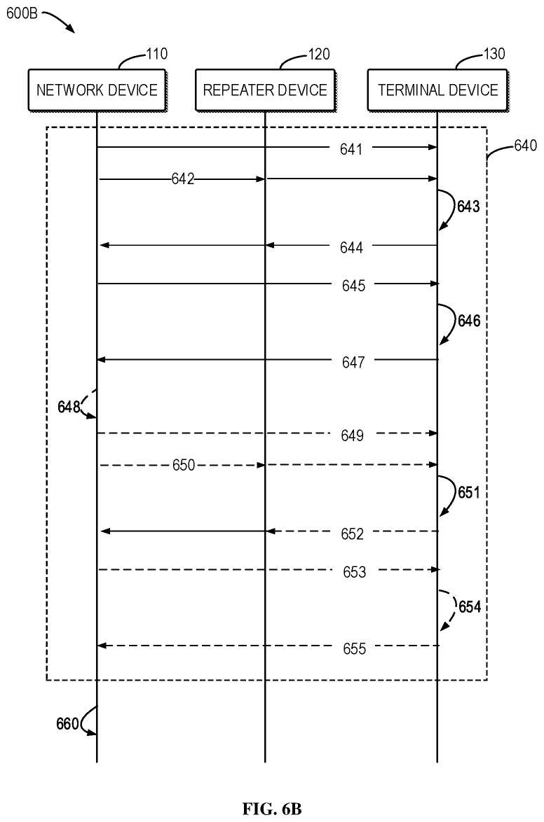

In this embodiment, the network device 110 may determine the second information (i.e., at least one of a power level or a hardware state of the repeater device 120), and determine the control information based on the second information. Some example embodiments will be described with reference to FIG. 6A.

FIG. 6A illustrates a schematic diagram illustrating an example process 600A for determining control information based on a repeater state according to embodiments of the present disclosure. For the purpose of discussion, in the following, the process 600A will be described with reference to FIG. 1. It is to be understood that the process 600A may include additional blocks not shown and/or may omit some blocks as shown, and the scope of the present disclosure is not limited in this regard.

As shown in FIG. 6A, the network device 110 may obtain 610 the second information from the repeater device 120.

In some embodiments, the repeater device 120 may transmit 611, to the network device 110, an indication indicating a type of a device for powering the repeater device 120. In some embodiments, the device for powering the repeater device 120 may be a power network. In some embodiments, the device for powering the repeater device 120 may be a power grid. In some embodiments, the device for powering the repeater device 120 may be an emergency generator. In some embodiments, the device for powering the repeater device 120 may be a battery: It is to be understood that the device for powering the repeater device 120 may be in any other suitable types.

In some embodiments, the network device 110 may transmit 612, to the repeater device 120, a configuration (for convenience, also referred to as a first configuration herein) indicating at least one of a resource or a period for updating the second information. Based on the first configuration, the repeater device 120 may transmit 613 the second information to the network device 110. In this way, the second information may be obtained in a periodic manner.

In some embodiments, the resource for updating the second information may be preconfigured with a period, and the period of the resource may be associated with the period for updating the second information.

In some embodiments, the network device 110 may determine the period for updating the second information based on the type of the device for powering the repeater device 120. In other words, the period is expected to be different for different types of the device for powering the repeater device 120. In some embodiments, a long period may be used for a power network or a power grid. In some embodiments, a medium period may be used for an emergency generator. In some embodiments, a short period may be used for a battery: It is to be understood that these are merely examples, and any other suitable ways are also feasible for determination of the period for updating the second information.

In some scenarios, if timelines of the period for updating the second information is configured to be too long, an incorrect timing may be caused. In view of this, in some embodiments, the network device 110 may transmit 614, to the repeater device 120 and in a time interval, a request for updating the second information. The time interval may be associated with the type of the device for powering the repeater device 120. In response to the request, the repeater device 120 may transmit 615 the second information to the network device 110. In this way, the second information may be obtained in an aperiodic manner.

Continue to refer to FIG. 6A, upon reception of the second information, the network device 110 may determine 620 the control information based on the second information. In some embodiments, an on-off state or transmit power may be associated with power supplied by the device for powering the repeater device 120. In some embodiments, if lower power is supplied, lower transmit power is used. For example, for a power network or grid, high transmit power may be used. For emergency generator, medium transmit power may be used. For battery; low transmit power may be used.

In some embodiments, the network device 110 may compare 621 a power level indicated by the second information with a threshold level. If the power level indicated by the second information is lower than or equal to the threshold level, the network device 110 may cause 622 the control information to indicate the turn-off of the repeater device 120. In some embodiments, if the power level is higher than the threshold level, the network device 110 may cause 623 the control information to indicate the turn-on of the repeater device 120.

In some embodiments, the threshold level may be associated with at least one of a service type or throughout. For example, if the service type indicates video, the threshold level may be a high threshold level. If the service type indicates figure, the threshold level may be a medium threshold level. If the service type indicates word or web message, the threshold level may be a low threshold level.

In some alternative or additional embodiments, if the second information comprises a hardware state and the hardware state indicates a hardware damage or failure of the repeater device 120, the network device 110 may cause the control information to indicate the turn-off of the repeater device 120.

With the second information reported by the repeater device, a proactive trigger based on the reported information is achieved for transmission of the on-off information.

As an alternative, a trigger based on the requirement of the repeater device may also be achieved for transmission of the on-off information. Continue to refer to FIG. 6A, in some embodiments, the repeater device 120 may transmit 630, to the network device 110, a request for turning off the repeater device 120.

For example, the repeater device 120 may determine whether the current power level is lower than or equal to a threshold level. If the current power level is lower than or equal to the threshold level, the repeater device 120 may transmit, to the network device 110, a request for turning off the repeater device 120. As another example, the repeater device 120 may determine whether a hardware damage or failure occurs in the repeater device 120. For example, if a temperature of the repeater device 120 exceeds a threshold temperature, the repeater device 120 may determine that the hardware damage or failure occurs. Of course, any other suitable ways are also feasible. In response to the occurring of the hardware damage or failure, the repeater device 120 may transmit, to the network device 110, a request for turning off the repeater device 120.

Upon reception of the request from the repeater device 120, the network device 110 may cause 631 the control information to indicate the turn-off of the repeater device 120.

It is to be understood that the repeater state may also adopt any other suitable forms, and any other suitable ways are also feasible for determination of the control information based on the repeater state.

### Embodiment 3

In this embodiment, the network device 110 may determine the third information (i.e., channel qualities of the indirect link (i.e., the first link) and the direct link (i.e., the second link) between the network device 110 and the terminal device 130), and determine the control information based on the third information. In fact, some damage or failure that cannot be detected by the repeater device 120 may be measured as part of a channel state. Some example embodiments will be described with reference to FIG. 6B.

FIG. 6B illustrates a schematic diagram illustrating an example process 600B for determining control information based on a repeater state according to embodiments of the present disclosure. For the purpose of discussion, in the following, the process 600B will be described with reference to FIG. 1. It is to be understood that the process 600B may include additional blocks not shown and/or may omit some blocks as shown, and the scope of the present disclosure is not limited in this regard.

As shown in FIG. 6B, the network device 110 may obtain 640 the third information from the repeater device 120.

In some embodiments, the network device 110 may transmit 641, to the terminal device 130, a configuration (for convenience, also referred to as a second configuration herein) indicating a first resource set and a second resource set. The first resource set is configured for a channel measurement (for convenience, also referred to as a first channel measurement herein) of the first link, and the second resource set is configured for a channel measurement (for convenience, also referred to as a second channel measurement herein) of the second link.

In some embodiments, the network device 110 may transmit 642, to the terminal device 130, a first set of reference signals over the first resource set. For example, the first set of reference signals may be a set of channel state CSI-RSs or any other suitable reference signals. In this case, the network device 110 may transmit the first set of reference signals to the repeater device 120, and the repeater device 120 may forward the first set of reference signals to the terminal device 130.

The terminal device 130 may perform 643 the first channel measurement on the first set of reference signals. In some embodiments, a result of the first channel measurement may be reference signal receive power (RSRP). In some embodiments, a result of the first channel measurement may be reference signal receive quality (RSRQ). It is to be understood that any other suitable forms are also feasible. The terminal device 130 may transmit 644 the result of the first channel measurement to the network device 110. For example, the terminal device 130 may transmit the result of the first channel measurement to the repeater device 120 and the repeater device 120 may forward the result of the first channel measurement to the network device 110.

In some embodiments, the network device 110 may transmit 645, to the terminal device 130, a second set of reference signals over the second resource set. For example, the second set of reference signals may be another set of channel state CSI-RSs or any other suitable reference signals. In this case, the network device 110 may transmit the second set of reference signals to the terminal device 130 directly.

Then the terminal device 130 may perform 646 the second channel measurement on the second set of reference signals. In some embodiments, a result of the second channel measurement may be RSRP. In some embodiments, a result of the first channel measurement may be RSRQ. It is to be understood that any other suitable forms are also feasible. The terminal device 130 may transmit 647 the result of the second channel measurement to the network device 110. For example, the terminal device 130 may transmit the result of the second channel measurement to the network device 110.

In some embodiments, the network device 110 may determine 648 a third resource set and a fourth resource set based on the results of the first and second measurements. The third resource set is configured for an interference measurement (for convenience, also referred to as a first interference measurement herein) of the first link, and the fourth resource set is configured for an interference measurement (for convenience, also referred to as a second interference measurement herein) of the second link. Then the network device 110 may transmit 649, to the terminal device 130, a configuration (for convenience, also referred to as a third configuration herein) indicating the third resource set and the fourth resource set.

The network device 110 may transmit 650, to the terminal device 130, a third set of reference signals over the third resource set. For example, the third set of reference signals may be a set of channel state CSI-RSs or any other suitable reference signals. In this case, the network device 110 may transmit the third set of reference signals to the repeater device 120, and the repeater device 120 may forward the third set of reference signals to the terminal device 130.

Then the terminal device 130 may perform 651 the first interference measurement on the third set of reference signals. In some embodiments, a result of the first interference measurement may be signal to interference plus noise ratio (SINR). It is to be understood that any other suitable forms are also feasible. The terminal device 130 may transmit 652 the result of the first interference measurement to the network device 110. For example, the terminal device 130 may transmit the result of the first interference measurement to the repeater device 120 and the repeater device 120 may forward the result of the first interference measurement to the network device 110.

The network device 110 may transmit 653, to the terminal device 130, a fourth set of reference signals over the fourth resource set. For example, the fourth set of reference signals may be a set of channel state CSI-RSs or any other suitable reference signals. In this case, the network device 110 may transmit the fourth set of reference signals to the terminal device 130 directly.

Then the terminal device 130 may perform 654 the second interference measurement on the fourth set of reference signals. In some embodiments, a result of the second interference measurement may be SINR. It is to be understood that any other suitable forms are also feasible. The terminal device 130 may transmit 655 the result of the second interference measurement to the network device 110. For example, the terminal device 130 may transmit the result of the second interference measurement to the network device 110 directly.

In some embodiments, the first and second resource sets may be used for the first and second channel measurements on a beam pair set. The beam pair set may comprise two subsets corresponding to two links respectively. Based on the results of the first and second channel measurements, M1 beam pairs in a subset of the beam pair set is chosen for the first interference measurement, and M2 beam pairs in another subset of the beam pair set is chosen for the second interference measurement. Based on the result of interference measurement for both M1 beam pairs and M2 beam pairs, one beam pair may be chosen as the final one. The values of M1 and M2 can be the same or different.

In some embodiments, the network device 110 may determine 660, based on the results of the first and second interference measurements, which one of the first link and the second link has the better channel quality. In some alternative embodiments, the network device 110 may determine, based on the results of the first and second channel measurements, which one of the first link and the second link has the better channel quality.

In some embodiments, if channel quality of the first link is lower than or equal to channel quality of the second link, the network device 110 may cause the control information to indicate the turn-off of the repeater device 120. If channel quality of the first link is higher than channel quality of the second link, the network device 110 may cause the control information to indicate the turn-on of the repeater device 120.

### Example Implementation of Transmission of On-Off Information

Return to FIG. 2, upon determination of the control information, the network device 110 transmits 230 the control information to the repeater device 120.

### 1. Resource Allocation

In some embodiments, the network device 110 may transmit 231, to the repeater device 120, a configuration (for convenience, also referred to as a fourth configuration herein) regarding resource allocation of the transmission of the control information.

In some embodiments, the fourth configuration may indicate an identity (ID) of a control resource set (CORESET) configured for the repeater device 120. For example, a dedicated CORESET may be configured for the transmission of the control information. As an example, a control channel element (CCE) may comprise N*6 resource blocks in frequency domain, where N denotes the number of bit 1 of the field frequencyDomainResources for the CORESET with the corresponding ID. As another example, the ID of the CORESET may be selected from {16˜19}. In some embodiment, the CORESET may be configured with the field precoderGranularity excluded. In some embodiments, the CORESET may be configured by changing some fields from mandatory to condition mandatory.

In some embodiments, the fourth configuration may indicate the maximum number (denoted as Nmax) of RBs configured for the repeater device 120. For example, Nmax=4, to minimum the CORESET size in frequency domain, leading a low complexity of blind detection. As another example, Nmax may be equal to the number of RBs for synchronization signal and physical broadcast channel (SSB), e.g., Nmax=20.

By configuring the maximum number of RBs, a resource on other position in frequency domain may be used for PDSCH or PDCCH transmission for UE. Thus, flexibility on resource allocation in frequency domain may be increased and higher resource utilization may be ensured.

By configuring the maximum number of RBs, a bandwidth part (BWP) supported by the repeater device may be minimized, and complexity introduced by detection of the control information may be decreased.

In some embodiments, by configuring the maximum number of RBs, resource position in frequency domain for the control information is fixed. For example, the control information may be located at the edge or middle of the whole carrier bandwidth, leading a low complexity of blind detection of side control information.

In some embodiments, dedicated resource block group (RBG) sizes may be defined for the repeater device to receive the control information, for example, a new configuration denotes as “Configuration 3” is added for RBG size definition. As a detailed embodiments, the starting point may be aligned with a RBG for PDSCH resource allocation for other UE.

| Bandwidth Part Size | Configuration 1 | Configuration 2 | Configuration 3 |
|---|---|---|---|
| 1-36 | 2 | 4 | 1 |
| 37-72 | 4 | 8 | 2 |
| 73-144 | 8 | 16 | 4 |
| 145-275 | 16 | 16 | 4 |

In some embodiments, the fourth configuration may indicate a set of BWPs configured for the repeater device 120. In some embodiments, the set of BWPs may be different from that for PDCCH or PDSCH transmission of UE. In some embodiments, the set of BWPs may be dedicated for the repeater device 120 to detect control information. In some embodiments, the set of BWPs may comprise one BWP. In some embodiments, the set of BWPs may comprise multiple BWPs. In some embodiments, different BWPs in the set may be activated by a medium access control (MAC) control element (CE) to resist frequency selectivity of channel. In some embodiments, different BWPs in the set may be activated in a predefined manner.

In some embodiments, the maximum bandwidth may be associated with capability of the repeater device 120. In some embodiments, the repeater device 120 may support a small value of the maximum bandwidth. In this way, complexity of the repeater device 120 may be reduced.

In some embodiments, the maximum number of symbols for duration of the CORESET may be increased. For example, the maximum number of symbols may be 14 symbols, i.e., a whole slot. In this way, time-division multiplexed demodulation reference signal (DMRS) ports for different repeaters may be supported. In addition, no influence on UE's procedure is introduced, and the resource may be avoided for PDSCH scheduling for UE by rate match pattern configuration. For example, the ID of the CORESET may be indicated in the rate match pattern configuration. As another example, the RB and symbol allocated for side control information may be indicated in the rate match pattern configuration.

It is to be understood that the present disclosure does not limit the configuration of the CORESET, and any other suitable ways are also feasible.

### 2. Transmission of On-Off Information

Continue to refer to FIG. 6B, the network device 110 may determine 232 a resource based on the fourth configuration, and transmit 233 the control information over the resource.

In some embodiments, the network device 110 may receive, from the repeater device 120, capability of the repeater device 120. For example, several capability levels may be predefined and the repeater device 120 may report one of the capability levels. Table 1 shows an example of the capability levels. In this example, the unit of T_{GAP} is symbol, and the value of T_{GAP} is scaled with SCS, which meets T_{GAP}=2^{μ} or T_{GAP}=2^{(μ-1)}.

TABLE 1
An Example of Capability Levels

| SCS | Capability 1 | Capability 2 |
|---|---|---|
| μ = 1 | 2 | 1 |
| μ = 2 | 4 | 2 |
| μ = 3 | 8 | 4 |
| μ = 4 | 16 | 8 |
| μ = 6 | 64 | 32 |
| μ = 7 | 128 | 64 |

It can be known that in the example of Table 1, the same absolute time for different SCSs is provided for T_{GAP}.

As another example, the capability levels may be predefined as shown in Table 2. In this example, the unit of T_{GAP} is symbol, and the value of T_{GAP} is exponentially increased with SCS.

TABLE 2
Another Example of Capability Levels

| SCS | Capability 1 | Capability 2 |
|---|---|---|
| μ = 1 | 2 | 1 |
| μ = 2 | 4 | 2 |
| μ = 3 | 6 | 4 |
| μ = 4 | 10 | 6 |
| μ = 6 | 32 | 20 |
| μ = 7 | 56 | 36 |

It can be known that in the example of Table 2, decreasing absolute time with increased SCS is provided for T_{GAP}.

In some embodiments, a reference SCS may be used to take place of the SCS of the resource carried the control information.

The network device 110 may determine a period of time (denoted as T_{GAP}) based on the capability of the repeater device 120 and subcarrier spacing (SCS) of the resource carrying the control information. In some embodiments, the unit of T_{GAP} may be symbol. In some embodiments, the unit of T_{GAP} may be slot. The network device 110 may transmit the control information at a timing earlier than a time of effectiveness of the control information by the period of time.

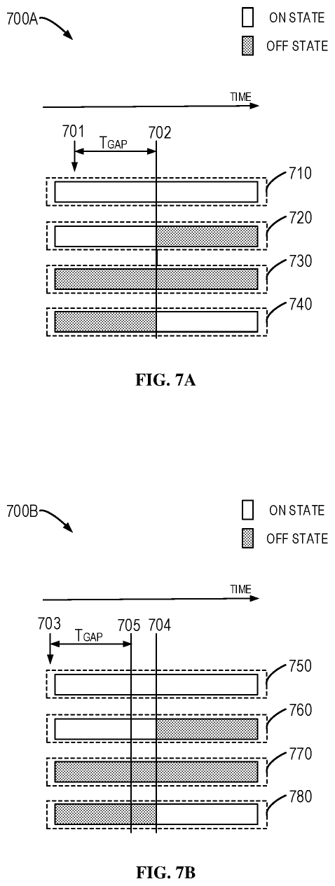

In other words, if an on-off state indicated by the control information is different from the current on-off state, the repeater device 120 may switch the on-off state after at least the period of time T_{GAP} from the last symbol of the resource carried the control information. For illustration, an example is describe below with reference to FIG. 7A.

FIG. 7A illustrates a schematic diagram 700A illustrating an example transmission of control information according to embodiments of the present disclosure. In this example, the unit of T_{GAP} is symbol and a granularity of on-off state switching is symbol.

As shown in FIG. 7A, the repeater device 120 may receive the control information at timing 701. If the current on-off state upon reception of the control information is on and an on-off state indicated by the control information is on, as shown by reference sign 710, the repeater device 120 may maintain the on state at the timing 702 later than the timing 701 by T_{GAP}. If the current on-off state upon reception of the control information is on and an on-off state indicated by the control information is off, as shown by reference sign 720, the repeater device 120 may switch to the off state at the timing 702. If the current on-off state upon reception of the control information is off and an on-off state indicated by the control information is off, as shown by reference sign 730, the repeater device 120 may maintain the off state at the timing 702. If the current on-off state upon reception of the control information is off and an on-off state indicated by the control information is on, as shown by reference sign 740, the repeater device 120 may switch to the on state at the timing 702.

FIG. 7B illustrates a schematic diagram 700B illustrating another example transmission of control information according to embodiments of the present disclosure. In this example, the unit of T_{GAP} is symbol and a granularity of on-off state switching is slot.

As shown in FIG. 7B, the repeater device 120 may receive the control information at timing 703. If the current on-off state upon reception of the control information is on and an on-off state indicated by the control information is on, as shown by reference sign 750, the repeater device 120 may maintain the on state at the first slot boundary (i.e., a timing 704) after the timing 705 later than the timing 703 by T_{GAP}. If the current on-off state upon reception of the control information is on and an on-off state indicated by the control information is off, as shown by reference sign 760, the repeater device 120 may switch to the off state at the timing 704. If the current on-off state upon reception of the control information is off and an on-off state indicated by the control information is off, as shown by reference sign 770, the repeater device 120 may maintain the off state at the timing 704. If the current on-off state upon reception of the control information is off and an on-off state indicated by the control information is on, as shown by reference sign 780, the repeater device 120 may switch to the on state at the timing 704.

In some embodiments, the network device 110 may transmit the control information via a wire link. For example, the network device 110 may transmit the control information via a cable or fiber between the network device 110 and the repeater device 120. It is to be understood that any other suitable wire links may also be feasible.

In some embodiments, the network device 110 may transmit the control information via a wireless link. For example, the network device 110 may transmit the control information via Wi-Fi, ZigBee, Bluetooth, LTE, CDMA, NR-FR1 or NR-FR2. It is to be understood that any other suitable wireless links may also be feasible.

In some embodiments, the period of time T_{GAP} may be associated with a communication scheme used for the transmission of the control information.

So far, determination and transmission of on-off information for a network-controlled repeater is achieved.

### Example Implementation of Methods

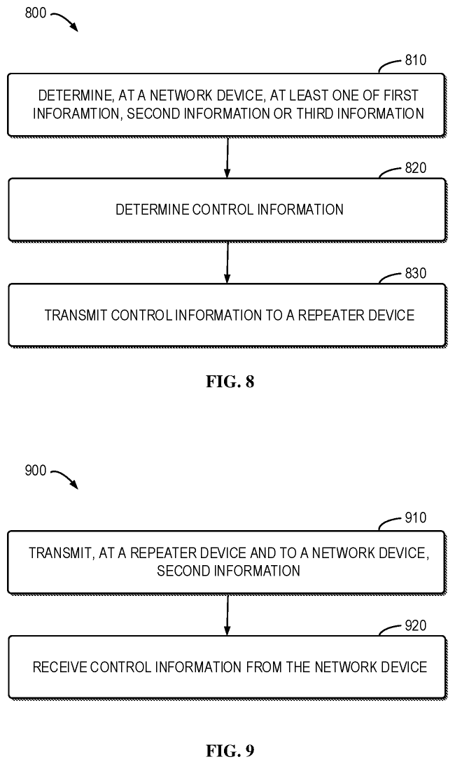

Accordingly, embodiments of the present disclosure provide methods of communication implemented at a network device, a repeater device and a terminal device. These methods will be described below with reference to FIGS. 8 to 10.

FIG. 8 illustrates an example method 800 of communication implemented at a network device in accordance with some embodiments of the present disclosure. For example, the method 800 may be performed at the network device 110 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

At block 810, the network device 110 determines at least one of first information, second information or third information, the first information indicating a time-division duplexing configuration for the terminal device 130, the second information indicating at least one of a power level or a hardware state of the repeater device 120, the third information indicating channel qualities of a first link between the network device and the terminal device via the repeater device and a second link between the network device and the terminal device.

At block 820, the network device 110 determines control information based on the at least one of the first information, the second information or the third information, the control information indicating turn-on or turn-off of the repeater device 120.

In some embodiments, the network device 110 may transmit, to the repeater device 120, a first configuration indicating at least one of a resource or a period for updating the second information, and receive the second information from the repeater device 120 based on the first configuration. In some embodiments, the network device 110 may determine the period based on a type of a device for powering the repeater device 120.

In some embodiments, if the power level is lower than or equal to a threshold level, the network device 110 may cause the control information to indicate the turn-off of the repeater device 120. If the power level is higher than a threshold level, the network device 110 may cause the control information to indicate the turn-on of the repeater device 120. In some embodiments, the threshold level is associated with at least one of a service type or throughout.

In some embodiments, the network device 110 may transmit, to the repeater device 120 and in a time interval, a request for updating the second information, the time interval being associated with a type of a device for powering the repeater device 120, and receive the second information from the repeater device 120.

In some embodiments, the network device 110 may further receive, from the repeater device 120, an indication indicating the type of the device for powering the repeater device.

In some embodiments, in response to receiving, from the repeater device 120, a request for turning off the repeater device 120, the network device 110 may cause the control information to indicate the turn-off of the repeater device 120.

In some embodiments, the network device 110 may transmit, to the terminal device 130, a second configuration indicating a first resource set and a second resource set, the first resource set being configured for a first channel measurement of the first link, the second resource set being configured for a second channel measurement of the second link. The network device 110 may transmit, to the terminal device 130, a first set of reference signals over the first resource set and a second set of reference signals over the second resource set and receive, from the terminal device 130, results of the first and second channel measurements.

In some embodiments, the network device 110 may further determine, based on the results of the first and second measurements, a third resource set and a fourth resource set, the third resource set being configured for a first interference measurement of the first link, the fourth resource set being configured for a second interference measurement of the second link, and transmit, to the terminal device 130, a third configuration indicating the third resource set and the fourth resource set. In these embodiments, the network device 110 may transmit, to the terminal device 130, a third set of reference signals over the third resource set and a fourth set of reference signals over the fourth resource set, and receive, from the terminal device 130, results of the first and second interference measurements.

In some embodiments, if channel quality of the first link is lower than or equal to channel quality of the second link, the network device 110 may cause the control information to indicate the turn-off of the repeater device 120. If channel quality of the first link is higher than channel quality of the second link, the network device 110 may cause the control information to indicate the turn-on of the repeater device 120.

At block 830, the network device 110 transmits the control information to the repeater device 120.

In some embodiments, the network device 110 may receive, from the repeater device 120, capability of the repeater device 120, and transmit the control information at a timing earlier than a time of effectiveness of the control information by at least a period of time, the period of time being associated with the capability of the repeater device 120 and a subcarrier spacing of a resource carrying the control information.

In some embodiments, the network device 110 may transmit a fourth configuration indicating at least one of the following: an identity of a control resource set configured for the repeater device 120, the maximum number of resource blocks configured for the repeater device 120, or a set of bandwidth parts configured for the repeater device 120. In some embodiments, the maximum number of symbols for a duration of the control resource set is 14.

In some embodiments, the network device 110 may determine a resource based on the fourth configuration, and transmit the control information over the resource.

In some embodiments, if a symbol in a slot indicated in the time-division duplexing configuration is a downlink symbol, the network device 110 may cause the control information to be to indicate the turn-on of the repeater device 120 for the slot. If symbols in a slot indicated in the time-division duplexing configuration are uplink symbols, the network device 110 may cause the control information to be to indicate the turn-off of the repeater device 120 for the slot.

In some embodiments, if at least one downlink transmission over a set of symbols indicated by a higher layer signaling conflicts with at least one uplink transmission scheduled by downlink control information, and the set of symbols and a set of uplink symbols form a slot, the network device 110 may cause the control information to be to indicate the turn-off of the repeater device 120 for the slot. In some embodiments, if at least one downlink transmission over a set of symbols conflicts with at least one uplink symbol indicated in the time-division duplexing configuration, and the set of symbols and a set of uplink symbols form a slot, the network device 110 may cause the control information to be to indicate the turn-off of the repeater device 120 for the slot.

In some embodiments, the network device 110 may cause the control information to be to indicate the turn-on of the repeater device 120 for a downlink symbol, and may cause the control information to be to indicate the turn-off of the repeater device for an uplink symbol.

In some embodiments, if a downlink transmission over a set of symbols indicated by a higher layer signaling conflicts with an uplink transmission scheduled by downlink control information, the network device 110 may cause the control information to be to indicate the turn-off of the repeater device 120 for the set of symbols. In some embodiments, if at least one downlink transmission over a set of symbols conflicts with at least one uplink symbol, the network device 110 may cause the control information to be to indicate the turn-off of the repeater device 120 for the set of symbols.

In some embodiments, the turn-on of the repeater device comprises turn-on of a downlink transceiver of the repeater device and turn-off of an uplink transceiver of the repeater device, and the turn-off of the repeater device comprises turn-off of the downlink transceiver of the repeater device and turn-on of the uplink transceiver of the repeater device.

With the method 800, determination and transmission of on-off information is defined.

FIG. 9 illustrates an example method 900 of communication implemented at a repeater device in accordance with some embodiments of the present disclosure. For example, the method 900 may be performed at the repeater device 120 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

At block 910, the repeater device 120 transmits, to the network device 110, second information indicating at least one of a power level or a hardware state of the repeater device.

In some embodiments, the repeater device 120 may receive, from the network device, a first configuration indicating at least one of a resource or a period for updating the second information, and transmit the second information to the network device based on the first configuration.

In some embodiments, the repeater device 120 may receive, from the network device 110 and in a time interval, a request for updating the second information, the time interval being associated with a type of a device for powering the repeater device, and transmit the second information to the network device 110 in response to the request.

At block 920, the repeater device 120 receives, from the network device 110, control information indicating turn-on or turn-off of the repeater device 120.

In some embodiments, if the power level is lower than or equal to a threshold level, the repeater device 120 may transmit, to the repeater device 120, a request for turning off the repeater device 120. In some embodiments, the threshold level may be associated with at least one of a service type or throughout.

In some embodiments, the repeater device 120 may further transmit, to the network device 110, an indication indicating a type of a device for powering the repeater device 120.

In some embodiments, the repeater device 120 may further transmit, to the network device 110, capability of the repeater device 120. In some embodiments, the repeater device 120 may turn on or turn off the repeater device 120 based on the control information at a timing later than a timing of the reception of the control information by a period of time. The period of time is associated with the capability of the repeater device 120 and a subcarrier spacing of a resource carrying the control information.

In some embodiments, the repeater device 120 may further receive a fourth configuration indicating at least one of the following: an identity of a control resource set configured for the repeater device 120, the maximum number of resource blocks configured for the repeater device 120, or a set of bandwidth parts configured for the repeater device 120. In some embodiments, the maximum number of symbols for a duration of the control resource set is 14.

In some embodiments, the repeater device 120 may receive the control information by performing a blind detection based on the fourth configuration.

With the method 900, a repeater device can report related information to a network device to facilitate the determination and transmission of on-off information.

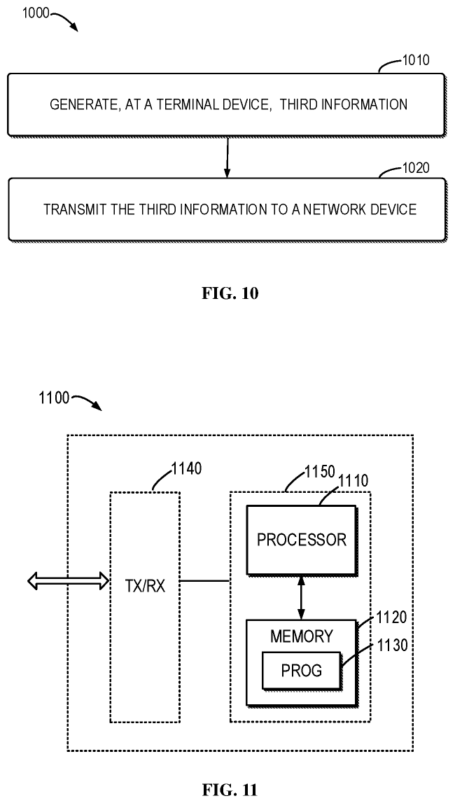

FIG. 10 illustrates an example method 1000 of communication implemented at a terminal device in accordance with some embodiments of the present disclosure. For example, the method 1000 may be performed at the terminal device 130 as shown in FIG. 1. For the purpose of discussion, in the following, the method 1000 will be described with reference to the terminal device 130 in FIG. 1. It is to be understood that the method 1000 may include additional blocks not shown and/or may omit some blocks as shown, and the scope of the present disclosure is not limited in this regard.

At block 1010, the terminal device 130 generates third information indicating channel qualities of a first link between the network device 110 and the terminal device 130 via the repeater device 120 and a second link between the network device 110 and the terminal device 130.

In some embodiments, the terminal device 130 may receive, from the network device 110, a second configuration indicating a first resource set and a second resource set, the first resource set being configured for a first channel measurement of the first link, the second resource set being configured for a second channel measurement of the second link. The terminal device 130 may perform the first and second channel measurements on a first set of reference signals received over the first resource set and a second set of reference signals received over the second resource set. Then the terminal device 130 may determine, as the third information, results of the first and second channel measurements.

In some embodiments, the terminal device 130 may further receive, from the network device, a third configuration indicating a third resource set and a fourth resource set, the third resource set being configured for a first interference measurement of the first link, the fourth resource set being configured for a second interference measurement of the second link. The terminal device 130 may perform the first and second interference measurements on a third set of reference signals received over the third resource set and a fourth set of reference signals received over the fourth resource set. Then the terminal device 130 may determine, as the third information, results of the first and second interference measurements.

At block 1020, the terminal device 130 transmits the third information to the network device 110.

With the method 1000, a terminal device may report channel state to a network device to facilitate determination of on-off information.

### Example Implementation of Device and Apparatus

FIG. 11 is a simplified block diagram of a device 1100 that is suitable for implementing embodiments of the present disclosure. The device 1100 can be considered as a further example implementation of the network device 110 or the repeater device 120 or the terminal device 130 as shown in FIG. 1. Accordingly, the device 1100 can be implemented at or as at least a part of the network device 110 or the repeater device 120 or the terminal device 130.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1110 stores at least a part of a program 1130. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1130 is assumed to include program instructions that, when executed by the associated processor 1110, enable the device 1100 to operate in accordance with the embodiments of the present disclosure, as discussed herein with reference to FIGS. 1 to 7B. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

In some embodiments, a network device comprises a circuitry configured to: determine at least one of first information, second information or third information, the first information indicating a time-division duplexing configuration for a terminal device, the second information indicating at least one of a power level or a hardware state of a repeater device, the third information indicating channel qualities of a first link between the network device and the terminal device via the repeater device and a second link between the network device and the terminal device: determine control information based on the at least one of the first information, the second information or the third information, the control information indicating turn-on or turn-off of the repeater device; and transmit the control information to the repeater device.

In some embodiments, the circuitry may be configured to determine the second information by transmitting, to the repeater device, a first configuration indicating at least one of a resource or a period for updating the second information and receiving the second information from the repeater device based on the first configuration.

In some embodiments, the circuitry may be configured to determine the control information by: in accordance with a determination that the power level is lower than or equal to a threshold level, causing the control information to indicate the turn-off of the repeater device; and in accordance with a determination that the power level is higher than a threshold level, causing the control information to indicate the turn-on of the repeater device. In some embodiments, the threshold level is associated with at least one of a service type or throughout.

In some embodiments, the circuitry may be further configured to determine the period based on a type of a device for powering the repeater device.

In some embodiments, the circuitry may be configured to determine the second information by: transmitting, to the repeater device and in a time interval, a request for updating the second information, the time interval being associated with a type of a device for powering the repeater device; and receiving the second information from the repeater device.

In some embodiments, the circuitry may be further configured to receive, from the repeater device, an indication indicating a type of a device for powering the repeater device.

In some embodiments, the circuitry may be configured to determine the control information by: in response to receiving, from the repeater device, a request for turning off the repeater device, causing the control information to indicate the turn-off of the repeater device.

In some embodiments, the circuitry may be configured to determine the third information by: transmitting, to the terminal device, a second configuration indicating a first resource set and a second resource set, the first resource set being configured for a first channel measurement of the first link, the second resource set being configured for a second channel measurement of the second link: transmitting, to the terminal device, a first set of reference signals over the first resource set and a second set of reference signals over the second resource set; and receiving, from the terminal device, results of the first and second channel measurements.

In some embodiments, the circuitry may be further configured to determine the third information by: determining, based on the results of the first and second measurements, a third resource set and a fourth resource set, the third resource set being configured for a first interference measurement of the first link, the fourth resource set being configured for a second interference measurement of the second link: transmitting, to the terminal device, a third configuration indicating the third resource set and the fourth resource set: transmitting, to the terminal device, a third set of reference signals over the third resource set and a fourth set of reference signals over the fourth resource set; and receiving, from the terminal device, results of the first and second interference measurements.

In some embodiments, the circuitry may be configured to determine the control information by: in accordance with a determination that channel quality of the first link is lower than or equal to channel quality of the second link, causing the control information to indicate the turn-off of the repeater device; and in accordance with a determination that channel quality of the first link is higher than channel quality of the second link, causing the control information to indicate the turn-on of the repeater device.

In some embodiments, the circuitry may be configured to transmit the control information by: receiving, from the repeater device, capability of the repeater device; and transmitting the control information at a timing earlier than a time of effectiveness of the control information by at least a period of time, the period of time being associated with the capability of the repeater device and a subcarrier spacing of a resource carrying the control information.

In some embodiments, the circuitry may be further configured to: transmit a fourth configuration indicating at least one of the following: an identity of a control resource set configured for the repeater device, the maximum number of resource blocks configured for the repeater device, or a set of bandwidth parts configured for the repeater device. In some embodiments, the maximum number of symbols for a duration of the control resource set is 14.

In some embodiments, the circuitry may be configured to transmit the control information by: determining a resource based on the fourth configuration; and transmitting the control information over the resource.

In some embodiments, the circuitry may be configured to determine the control information by: in accordance with a determination that a symbol in a slot indicated in the time-division duplexing configuration is a downlink symbol, causing the control information to be to indicate the turn-on of the repeater device for the slot: or in accordance with a determination that symbols in a slot indicated in the time-division duplexing configuration are uplink symbols, causing the control information to be to indicate the turn-off of the repeater device for the slot.

In some embodiments, the circuitry may be configured to determine the control information by: in accordance with a determination that at least one downlink transmission over a set of symbols indicated by a higher layer signaling conflicts with at least one uplink transmission scheduled by downlink control information, and the set of symbols and a set of uplink symbols form a slot, causing the control information to be to indicate the turn-off of the repeater device for the slot: or in accordance with a determination that at least one downlink transmission over a set of symbols conflicts with at least one uplink symbol indicated in the time-division duplexing configuration, and the set of symbols and a set of uplink symbols form a slot, causing the control information to be to indicate the turn-off of the repeater device for the slot.

In some embodiments, the circuitry may be configured to determine the control information by: causing the control information to be to indicate the turn-on of the repeater device for a downlink symbol: or causing the control information to be to indicate the turn-off of the repeater device for an uplink symbol.

In some embodiments, the circuitry may be configured to determine the control information by: in accordance with a determination that a downlink transmission over a set of symbols indicated by a higher layer signaling conflicts with an uplink transmission scheduled by downlink control information, causing the control information to be to indicate the turn-off of the repeater device for the set of symbols: or in accordance with a determination that at least one downlink transmission over a set of symbols conflicts with at least one uplink symbol, causing the control information to be to indicate the turn-off of the repeater device for the set of symbols.

In some embodiments, the turn-on of the repeater device comprises turn-on of a downlink transceiver of the repeater device and turn-off of an uplink transceiver of the repeater device, and the turn-off of the repeater device comprises turn-off of the downlink transceiver of the repeater device and turn-on of the uplink transceiver of the repeater device.

In some embodiments, a repeater device comprises a circuitry configured to: transmit, to a network device, second information indicating at least one of a power level or a hardware state of the repeater device; and receive, from the network device, control information indicating turn-on or turn-off of the repeater device.

In some embodiments, the circuitry may be configured to transmit the second information by: receiving, from the network device, a first configuration indicating at least one of a resource or a period for updating the second information; and transmitting the second information to the network device based on the first configuration.

In some embodiments, the circuitry may be further configured to: in accordance with a determination that the power level is lower than or equal to a threshold level, transmit, to the repeater device, a request for turning off the repeater device. In some embodiments, the threshold level is associated with at least one of a service type or throughout.

In some embodiments, the circuitry may be configured to transmit the second information by: receiving, from the network device and in a time interval, a request for updating the second information, the time interval being associated with a type of a device for powering the repeater device; and transmitting the second information to the network device in response to the request.

In some embodiments, the circuitry may be further configured to transmit, to the network device, an indication indicating a type of a device for powering the repeater device.

In some embodiments, the circuitry may be further configured to transmit, to the network device, capability of the repeater device; and turn on or turn off the repeater device based on the control information at a timing later than a timing of the reception of the control information by a period of time, the period of time being associated with the capability of the repeater device and a subcarrier spacing of a resource carrying the control information.

In some embodiments, the circuitry may be further configured to receive a fourth configuration indicating at least one of the following: an identity of a control resource set configured for the repeater device, the maximum number of resource blocks configured for the repeater device, or a set of bandwidth parts configured for the repeater device. In some embodiments, the maximum number of symbols for a duration of the control resource set is 14.

In some embodiments, the circuitry may be configured to receive the control information by receiving the control information by performing a blind detection based on the fourth configuration.

In some embodiments, a terminal device comprises a circuitry configured to:

generate third information indicating channel qualities of a first link between a network device and the terminal device via a repeater device and a second link between the network device and the terminal device; and transmit the third information to the network device.

In some embodiments, the circuitry may be configured to generate the third information by: receiving, from the network device, a second configuration indicating a first resource set and a second resource set, the first resource set being configured for a first channel measurement of the first link, the second resource set being configured for a second channel measurement of the second link: performing the first and second channel measurements on a first set of reference signals received over the first resource set and a second set of reference signals received over the second resource set; and determining, as the third information, results of the first and second channel measurements.

In some embodiments, the circuitry may be configured to generate the third information by: receiving, from the network device, a third configuration indicating a third resource set and a fourth resource set, the third resource set being configured for a first interference measurement of the first link, the fourth resource set being configured for a second interference measurement of the second link: performing the first and second interference measurements on a third set of reference signals received over the third resource set and a fourth set of reference signals received over the fourth resource set; and determining, as the third information, results of the first and second interference measurements.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 7B. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-36. (canceled)

37. A method performed by a repeater, comprising:
transmitting, to a network device, a capability information of the repeater, wherein the capability information indicates a number of slots;
receiving, from the network device, control information used for a link between the repeater and a terminal device; and
determining, a resource indicated by the control information, based on the number of slots and time resource for the control information.

38. The method of claim 37, further comprising:
receiving, from the network device, a time division duplexing (TDD) configuration, wherein the TDD configuration indicates uplink symbols and downlink symbols used for transmission and reception of the repeater.

39. The method of claim 37, the number of slots is associated with a subcarrier spacing (SCS) of reception of the control information.

40. A method performed by a network device, comprising:
receiving, from a repeater, a capability information of the repeater, wherein the capability information indicates a number of slots;
transmitting, to the repeater, control information used for a link between the repeater and a terminal device, wherein a resource indicated by the control information is determined based on the number of slots and time resource for the control information.

41. The method of claim 40, further comprising:
transmitting, to the repeater, a time division duplexing (TDD) configuration, wherein the TDD configuration indicates uplink symbols and downlink symbols used for transmission and reception of the repeater.

42. The method of claim 40, the number of slots is associated with a subcarrier spacing (SCS) of reception of the control information.

43. A repeater comprising a processor configured to cause the repeater to:
transmit, to a network device, a capability information of the repeater, wherein the capability information indicates a number of slots;
receive, from the network device, control information used for a link between the repeater and a terminal device; and
determine, a resource indicated by the control information, based on the number of slots and time resource for the control information.

44. The repeater of claim 43, the processor is further configured to cause the repeater to:
receive, from the network device, a time division duplexing (TDD) configuration, wherein the TDD configuration indicates uplink symbols and downlink symbols used for transmission and reception of the repeater.

45. The repeater d of claim 43, the number of slots is associated with a subcarrier spacing (SCS) of reception of the control information.

46. A network device comprising a processor configured to cause the network device to:
receive, from a repeater, a capability information of the repeater, wherein the capability information indicates a number of slots;
transmit, to the repeater, control information used for a link between the repeater and a terminal device, wherein a resource indicated by the control information is determined based on the number of slots and time resource for the control information.

47. The network device of claim 46, the processor is further configured to cause the network device to:
transmit, to the repeater, a time division duplexing (TDD) configuration, wherein the TDD configuration indicates uplink symbols and downlink symbols used for transmission and reception of the repeater.

48. The network device of claim 46, the number of slots is associated with a subcarrier spacing (SCS) of reception of the control information.
